(19) United States
(12) Patent Application Publication
(10) Pub. No.: US 2014/0209735 A1
(43) Pub. Date: Jul. 31, 2014

(54) ROTARY WING PLATFORM CONTAINMENT STRUCTURE FOR VERTICAL SURFACE TRANSFER

(71) Applicant: Peter L. Corey, Whitefield, NH (US)

(72) Inventor: Peter L. Corey, Whitefield, NH (US)

(21) Appl. No.: 14/163,053

(22) Filed: Jan. 24, 2014

Related U.S. Application Data
(60) Provisional application No. 61/757,894, filed on Jan. 29, 2013.

(51) Int. Cl. B64D 9/00; B64D 45/02; B64D 45/00

(52) U.S. Cl. CPC B64D 9/00; B64D 45/00; B64D 45/02
USPC 244/1 A; 244/137.1; 244/121

(57) ABSTRACT

A method, device, and system for rotary wing aircraft for the purpose of rescuing trapped or injured people from vertical surfaces and structures, and transferring individuals or objects at vertical surfaces generally. The device consists of a containment structure, boom, counterweight, attachment point, and cockpit controls. The device is quickly attached to specially modified and equipped rotary wing aircraft, and placed in service to rescue people trapped in a high-rise building due to fire or other hazard and to rescue trapped or injured hikers and climbers from steep mountainous terrain or vertical rock surfaces. Applications include depositing personnel onto a vertical surface or the upper reaches of a vertical structure.

### RELATED APPLICATIONS

This application claims the benefit of U.S. Provisional Application No. 61/757,894, filed Jan. 29, 2013. This application is herein incorporated in its entirety by reference.

### FIELD OF THE INVENTION

The invention relates to a method, system, and mechanical device for attachment to rotary wing aircraft for the purpose of transferring or rescuing trapped or injured people from vertical surfaces and structures or for transferring equipment and materials to and from vertical surfaces.

### BACKGROUND OF THE INVENTION

Life-saving rescues from burning high-rise buildings are extremely difficult, if not impossible. Rescues are especially difficult when roof access is blocked, and upper-level floors are involved. Once out of reach of ladders from below, individuals unable to evacuate by stairs may have little or no hope of escaping to safety. Similarly, window washers of high rise buildings in instances when the scaffolding equipment has malfunctioned can be stranded beyond the reach of legacy rescue systems. Access to vertical faces in general is difficult.

Current options may include rotary wing aircraft with an added hoist and cable to raise or lower personnel and equipment between the aircraft and a horizontal surface. Hoist and cable technology has proven effective and is in use the world over, predominantly by military services for maritime rescue operations. Unfortunately, hoist and cable technology is subject to the buffeting effects of wind at the end of the hoist cable, and is difficult to position at the desired transfer point. The ability to access a desired transfer point is also limited by the hoist cable length. For example, a climber injured and trapped on a vertical cliff is totally inaccessible via hoist cable if he/she is positioned below the upper reaches of the vertical surface, beyond the length of cable from an aircraft hovering above the cliff top.

What is needed is a device for transferring individuals or objects at vertical surfaces such as structures and cliffs.

### SUMMARY OF THE INVENTION

Invention embodiments, in contrast to hoist and cable technology, comprise a Containment Structure (CS) rigidly affixed to a helicopter. The Containment Structure and its contents remain wholly attached, and an integral part of the airframe throughout the transfer process. The CS is not subject to the buffeting effects of wind on the end of a hoist cable, and thus can be positioned exactly at the desired transfer point. The ability to access a desired transfer point is also not limited by hoist cable length. Both trapped occupants of a burning building and injured climbers are accessible for saving.

Embodiments provide a vertical surface transfer device attachable to a platform for transferring payloads proximate vertical surfaces comprising at least one boom; a delivery component at a forward end of the boom; at least one attachment point connecting the boom to the platform; and at least one cockpit control in the platform to control an aspect of the delivery component. For other embodiments the platform is a helicopter wherein the boom extends beyond the maximum reach of the main rotor. In another embodiment the delivery component comprises a containment structure. For further embodiments the delivery component comprises an open-top box structure. In still other embodiments the delivery component comprises a nozzle. Further embodiments include a mesh screen; a heat shield; a static discharge probe; a transfer platform; forward end doors; a range finder; and at least one anti-vibration component. Included embodiments comprise at least one counterweight comprising screw, motor, and mass components. Still other embodiments have at least one counterweight comprising a liquid equilibrium system.

Another embodiment provides a method for transferring individuals and objects at vertical surfaces comprising attaching a delivery system to a rotary wing aircraft, the delivery system comprising a delivery component, at least one boom, at least one attachment point, and at least one cockpit control; elevating to the site of the vertical surface; maneuvering the rotary aircraft into a transfer position; maintaining the transfer position; and performing the transfer. Additional embodiments include at least one counterweight for the delivery system and a counterweight calibration step. Other embodiments comprise detaching and removing the delivery system after landing after the transfer step. Still other embodiments involve delivery system jettison upon an emergency. Related embodiments comprise adding a payload to the delivery component prior to the elevating step.

A further embodiment provides a system for transferring individuals and objects at vertical surfaces comprising at least one boom extending beyond a maximum reach of a main rotor of a rotary wing aircraft, the boom fitting entirely between the ground surface and the bottom of the aircraft, the boom structure comprising parallel rails and cross members; the parallel rails interlocked with each other via horizontal angular cross members, the width of the boom being uniform along its length; at least one attachment point between the boom and the aircraft, the at least one attachment point configured to jettison the system from the aircraft by the cabin crew of the aircraft to preserve the safety of the aircraft and the crew; a protected jettison switch to activate jettisoning the system from the aircraft; a containment structure comprising attachment points for safety straps, one towards a front, and one towards a rear of the containment structure, the width of the containment structure equal to the width of the boom; a mesh screen providing enclosure for the containment structure; a heat shield beneath the containment structure; a transfer platform, constructed to slide in and out of a space between a bottom of the containment structure and the heat shield, the transfer platform acting as a bumper; forward end walls of the containment structure, extending forward in an open position to equal the length of the transfer platform, the forward end walls being compressible, movable toward the rear of the containment structure, the forward end walls forming gates of the containment structure, the gates having a closed and overlapped locked position providing secure transport; motors and motor housings on the outside of the containment structure at the forward end controlling the forward end gates; a compressible static discharge probe comprising a metal rod mounted underneath the containment structure; a laser range finder and an indicator displaying a distance between the containment structure and a rescue surface; at least one camera, spotlight, video screen, loudspeaker, microphone, and at least one switch to enable a pilot or a copilot to communicate with a person in the containment structure via at least one of the loudspeaker and a headset supporting two-way communication between the crew and an individual equipped with a headset riding in the containment structure, the spotlights, loudspeaker, and intercom housing mounted inside and on the aft end of the containment structure; an anti-vibration component preventing harmonic vibration; four casters mounted on the bottom of the boom, two on each bottom rail of the boom, one forward and one aft, which enable the system to be wheeled into place for mounting beneath the aircraft; at least one counterweight at least partially offsetting the weight of the contents of the containment structure; and a counterweight screw, counterweight motor, and counterweight mass, and a liquid equilibrium system, the counterweight mass and the counterweight screw mounted within interior aft end of the boom, the counterweight screw extending through the center of the counterweight mass to the counterweight motor, wherein the counterweight mass, counterweight motor, and counterweight screw are mounted wholly within the frame of the boom, the liquid equilibrium system comprising a closed bladder and reservoir system containing a liquid of a specific density, and a forward bladder connected via a liquid transfer conduit to an aft bladder contained in a sealed and pressurized liquid reservoir located in the aft section of the boom.

### BRIEF DESCRIPTION OF THE DRAWINGS

FIG. 1 is a depiction of the system in-use for a burning high-rise building rescue configured in accordance with an embodiment.

FIG. 2 is a depiction of the system in-use for cliff rescue configured in accordance with an embodiment.

FIG. 3 is a depiction of the system in-use for personnel transfer at a mountain top configured in accordance with an embodiment.

FIG. 4 illustrates alternate embodiment structures configured in accordance with an embodiment.

FIG. 5 illustrates a side view of the system configured in accordance with an embodiment.

FIG. 6 illustrates a top view of the system configured in accordance with an embodiment.

FIG. 7 illustrates a forward section of the boom with a containment structure configured in accordance with an embodiment.

FIG. 8 illustrates a forward end view configured in accordance with an embodiment.

FIG. 9 illustrates an aft section of the boom with counterweight and counterweight motor configured in accordance with an embodiment.

FIG. 10 illustrates an aft section of boom end view configured in accordance with an embodiment.

FIG. 11 illustrates a top view, without aircraft, configured in accordance with an embodiment.

FIG. 12 illustrates a bottom view of the device configured in accordance with an embodiment.

FIG. 13 illustrates a forward section of the boom with a liquid equilibrium component configured in accordance with an embodiment.

FIG. 14 illustrates an aft section of the boom with a liquid equilibrium component configured in accordance with an embodiment.

FIG. 15 is a flow chart of a method configured in accordance with an embodiment.

### DETAILED DESCRIPTION

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The invention is susceptible of many embodiments. What follows is illustrative, but not exhaustive, of the scope of the invention.

The invention includes a mechanical device for attachment to rotary wing aircraft or similar platforms, including drones, for the purpose of transferring objects or people, including rescuing trapped or injured people from vertical surfaces and structures. Embodiments can also be used in reverse to deposit personnel or equipment onto a vertical surface or the upper reaches of a vertical structure.

Embodiments of the device can be quickly attached to specially modified and equipped rotary wing aircraft or similar platforms, including drones, and placed in service to rescue people trapped in a high-rise building due to fire or other hazard and to rescue trapped or injured hikers and climbers from steep mountainous terrain or vertical rock surfaces.

Embodiments of the device comprise a containment structure, boom, counterweight, an attachment point, and cockpit controls. Further embodiments comprise a variety of structures, or absence thereof, substituted for the CS. Nonlimiting examples include an open platform for the movement of materials, and a spray nozzle, pump, and tank for the direct application of fire suppressant or foam. Additional embodiments are envisioned that exploit the ability to have positive control over the end of the boom and the point of transfer.

Following paragraphs describe details of components including the containment structure, boom, counterweight, attachment point, and cockpit controls. These will be further detailed with respect to the figures.

### Containment Structure (CS)

In embodiments, a containment structure (CS) is attached to the end of a boom which extends beyond the front cockpit and rotor reach of the aircraft. Embodiments of the CS are of sufficient size and construction to accommodate a litter patient or able-bodied person. They have a solid bottom equipped with a heat shield to protect the occupant from burns caused by heat rising from fires below the point of rescue. The heat shield is so attached as to slide rearward to allow for the movement of the aircraft against the vertical surface. For embodiments, the sides and ends of the CS are constructed of a mesh screen material to provide the aircrew greater visibility of the CS occupant and vertical surface and to promote the free flow of air so as to reduce any buffeting effect on the aircraft. Embodiments of the CS employ an open top, or alternatively a removable wire mesh screen cover. This top mesh provides a higher, 360 degrees, of security and positive safety for persons or equipment contained within. The end of the CS pointing away from the aircraft serves as the entry and exit point and is referred to as the Forward End (FE). Embodiments of the FE wall are motorized to open and close for loading and unloading of the CS. A horizontal rectangular transfer platform protrudes forward of the CS and boom and serves as the point of contact between the embodiment and the vertical surface. The transfer platform is further constructed to slide in and out of the space between the CS bottom and heat shield. In this manner, it acts as a bumper and provides a degree of cushion and compression between the aircraft and vertical surface. For embodiments, the FE walls extend forward in the open position to equal the length of the FE transfer platform in order to provide for secure transfer of persons and equipment from the vertical surface to the interior of the CS or vice versa. The FE walls are also compressible to accommodate the slight movement of the aircraft against the vertical surface. A static discharge probe in the form of a small metal rod is mounted underneath the CS and extends well beyond the FE of the CS for embodiments. This probe touches the vertical surface first to protect personnel moving between the vertical surface and CS from electric shock. The probe is compressible to accommodate the movement of the aircraft. A camera, lights, loud speaker, and laser range finder are mounted on the CS for embodiments. These devices are connected to the cockpit and provide the crew full situational awareness of the vertical surface and persons in the CS. This facilitates operations during reduced visibility, provides a means for the crew to give instructions to the person(s) entering or exiting the CS, and provides the crew with exact distance between the vertical surface and contact with the CS. CS embodiments also have a connector box to the aircrew's intercom system to enable 2-way conversation between the crew and someone equipped with a headset riding in the CS. Two safety harness attachment points, one fore and one aft, are located in the floor of the CS.

### Boom

For embodiments, the boom extends forward to the CS and rearward to a counterweight from a mounting point beneath the aircraft center of gravity. The boom is constructed of sufficient material and design to support the CS, counterweight, and associated equipment while fitting entirely between the ground surface and bottom of the aircraft. As a function of airworthiness the boom is so constructed and attached to the aircraft in such a fashion as to prevent any harmonic vibration of the entire device. Four casters mounted on the bottom of the boom enable the entire device to be easily and quickly wheeled into place for mounting beneath the aircraft.

### Counterweight

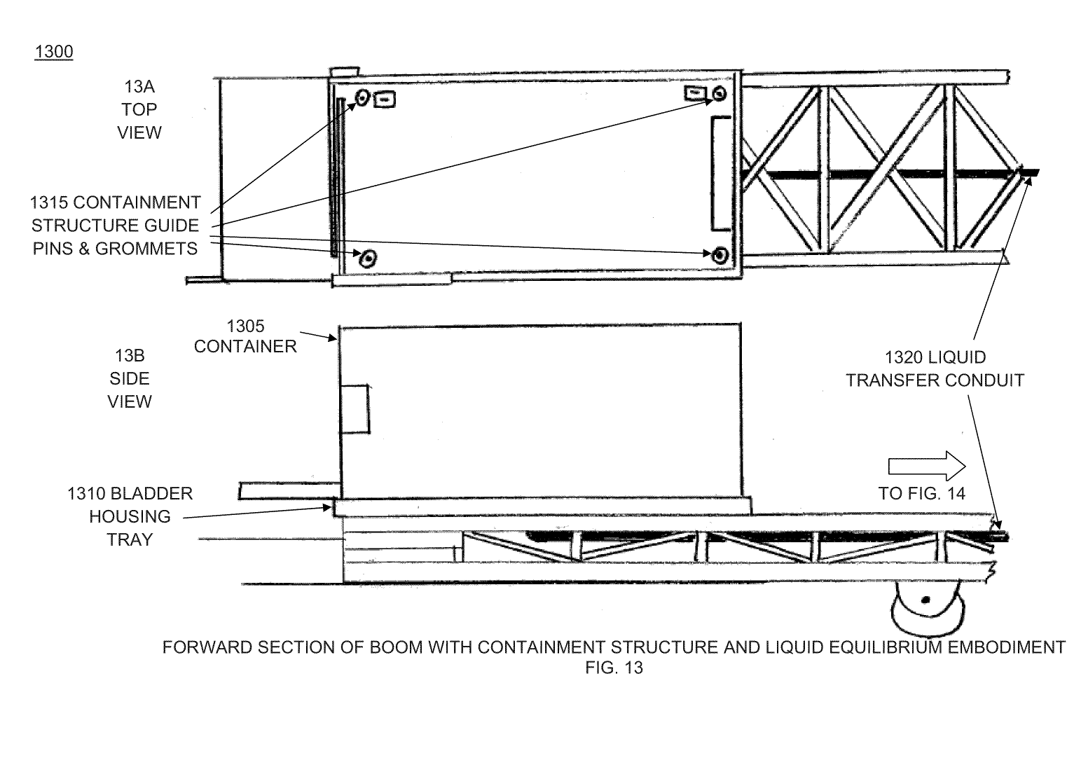

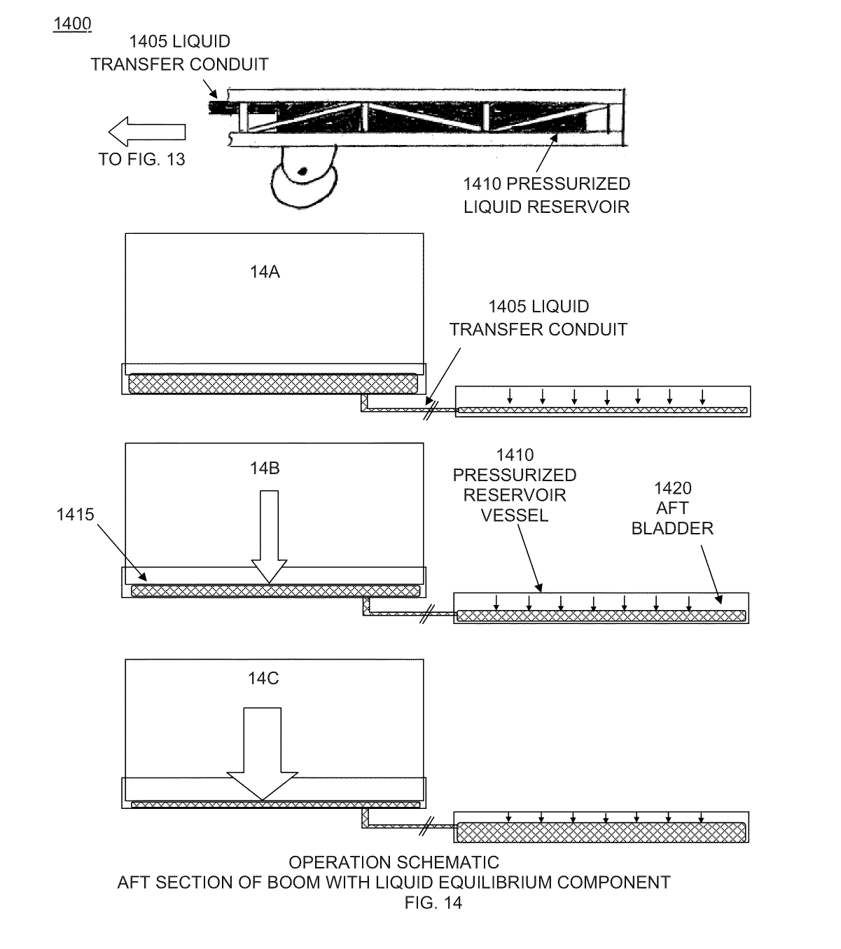

Embodiments include at least one Counterweight (CW) wholly contained within the frame of that portion of the boom that extends from the attachment point toward the rear of the aircraft. The CW is of sufficient mass to compensate for the weight of the CS, forward boom, and any CS load. An elongated screw extends from a motor located near the mounting point of the boom through the CW and is secured on the aft end of the boom. Turning the screw results in movement of the CW fore and aft. Sensors mounted beneath the CS determine the presence of any load and send data to an electronic processor which determines the correct position that the CW must be in to maintain the aircraft's center of gravity. The processor sends signals to the CW motor which turns the screw in the correct direction and by the proper amount to appropriately position the CW for the given load. Other counterweight moving mechanisms providing sufficient speed and mass to counter shifts of weight during operation are included as embodiments. One different counterweight implementation is a liquid equilibrium system; details are disclosed in FIGS. 13 and 14. Embodiments comprise both screw, motor, and mass and a liquid equilibrium system.

### Attachment Point

In embodiments, the CW, Boom, and CS are combined as one device and constructed in a manner such that they may be attached to the bottom of the aircraft in a matter of minutes. The attachment point(s) is constructed and equipped so that the cabin crew can jettison the device if necessary to preserve the safety of the aircraft and crew. All electrical cables between the device and aircraft will be connected via one coupler which will disconnect or breakaway if the device is jettisoned.

### Cockpit Controls

Because of the forward position of the CS, in embodiments, it would be difficult for any crewmember other than the pilot or co-pilot to operate the device. For embodiments, specific additions to the flight controls in the cockpit would include 1) video screen(s) to receive the video from the CS camera; 2) controls to turn the CS lights on or off; 3) indicator displaying the distance between the CS and rescue surface; 4) switch(es) to enable the pilot or copilot to communicate to the person(s) in the CS via the loudspeaker; 5) switch(es) to open or close the CS Forward End doors; and 6) a protected switch to jettison the device.

Embodiment details will now be described with respect to the Figures.

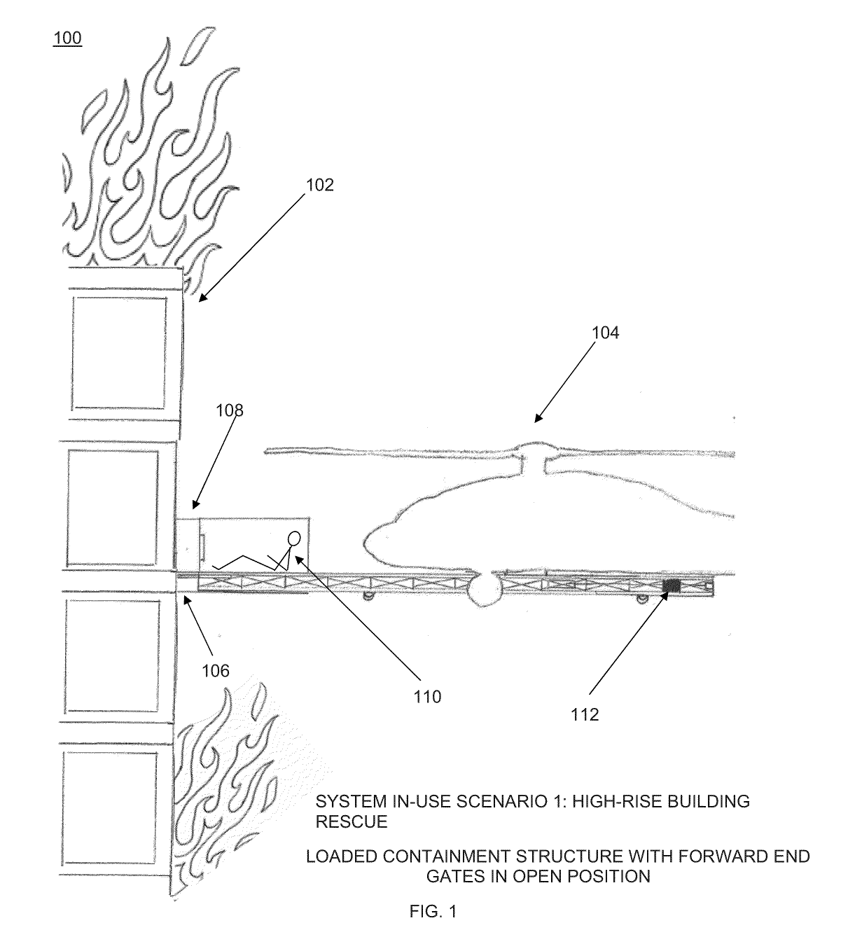

FIG. 1 illustrates an embodiment 100 of the device being used to rescue a trapped person from burning high rise building 102. In this figure, aircraft 104 is maneuvered to place the transfer platform in contact with the vertical surface exactly at the desired point of rescue 106. The Forward End gates of CS 108 are in the open and locked position providing secure transfer for the person moving between the vertical surface and the CS. The aircrew monitors the position of the CS and the aircraft's position relative to the vertical surface both visually and via the cockpit controls and sensors mounted on the CS. The aircrew is able to communicate instructions and reassurance to the trapped person via the loudspeaker mounted on the CS. The rescued person has entered the CS and is lying horizontally 110. The additional weight in the CS is detected by sensors resulting in a repositioning of CW 112 toward the rear of the boom to maintain the aircraft's center of gravity.

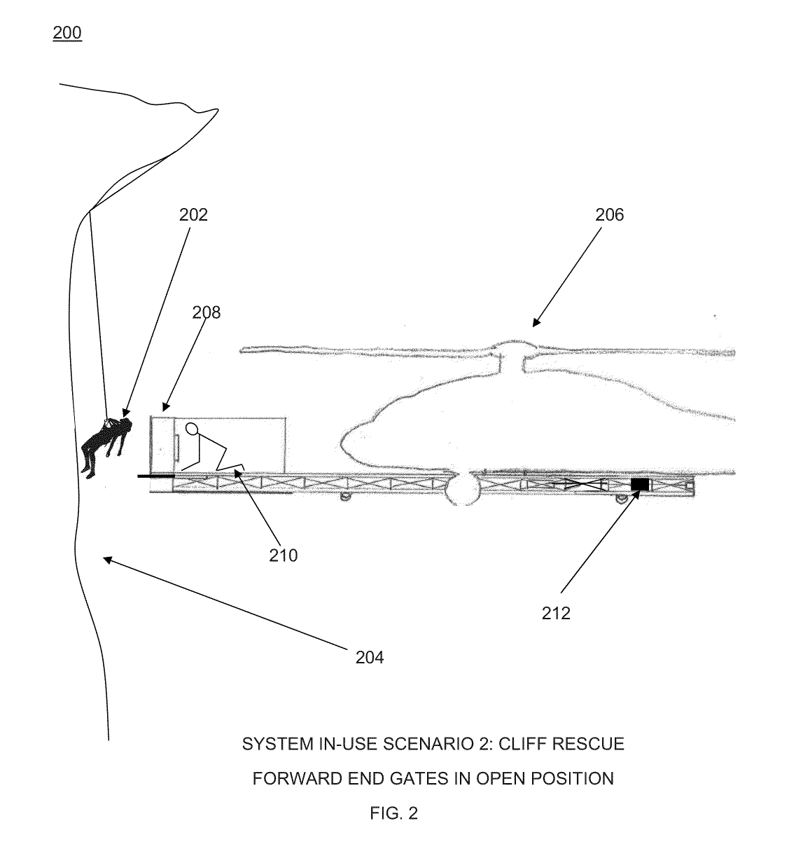

FIG. 2 illustrates an embodiment 200 of the device being used to rescue injured climber 202 from cliff 204. In this figure, aircraft 206 is maneuvered to place the transfer platform in contact with the vertical surface exactly at the desired point of rescue. The Forward End gates of the CS are in the open and locked position 208 providing secure transfer for the person moving between the vertical surface and the CS. In embodiments, the CS is an open-top box structure. Because the climber is injured and requires assistance, a rescuer 210 is positioned in the CS to aid the injured climber's transfer into the CS. The rescuer is connected to the CS via a safety strap and communicates to the aircrew via a headset connected to the intercom connector box attached to the CS. The aircrew monitors the position of the CS and the aircraft's position relative to the vertical surface visually, via the cockpit controls and sensors mounted on the CS, and by communicating to the rescuer in the CS. The Counterweight (CW) is positioned further aft 212 of the normal stored position to compensate for the additional load of the rescuer in the CS.

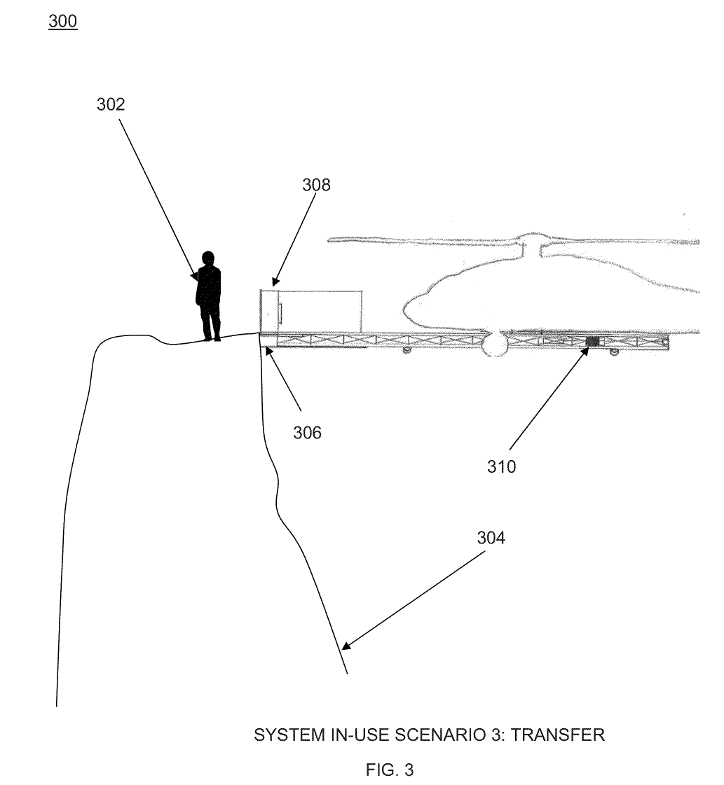

FIG. 3 illustrates an embodiment 300 of the device being used to insert law enforcement officer or military person 302 atop a vertical land mass 304. In this figure the aircraft is maneuvered to place the transfer platform in contact with the vertical surface exactly at the desired point of insertion 306. The Forward End gates of the CS are in the open and locked position 308 providing secure transfer for the person moving from the CS to the vertical surface. The aircrew monitors the position of the CS and the aircraft's position relative to the vertical surface visually, via the cockpit controls and sensors mounted on the CS. The Counterweight (CW) is positioned in normal stored position 310 as there is no additional load on the CS.

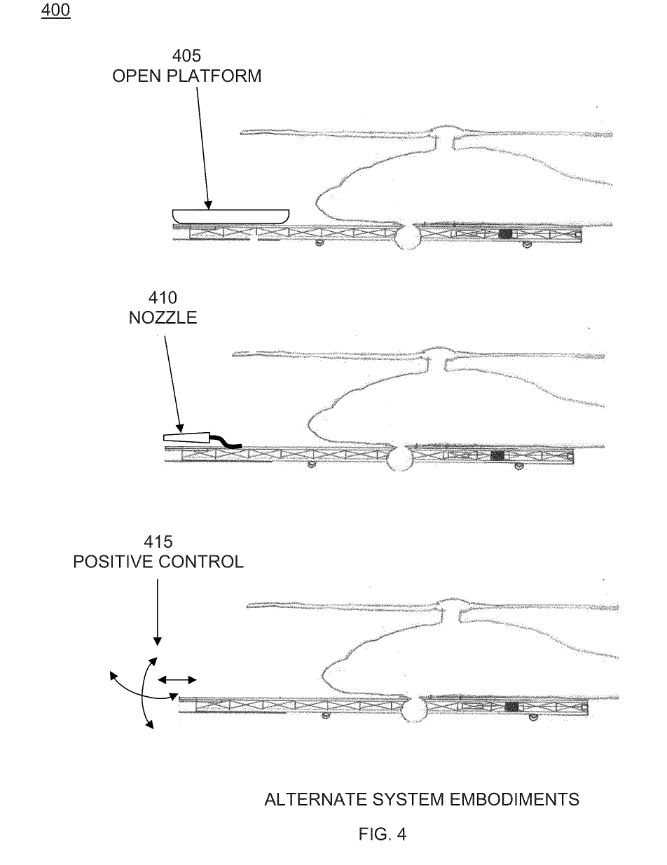

FIG. 4 depicts further embodiments 400 comprising a variety of structures for the CS. Nonlimiting examples include open platform 405 for the movement of materials, and spray nozzle 410, pump, and tank for the direct application of fire suppressant or foam. Additional embodiments 415 are envisioned that exploit the ability to have position control over the end of the boom and the point of transfer.

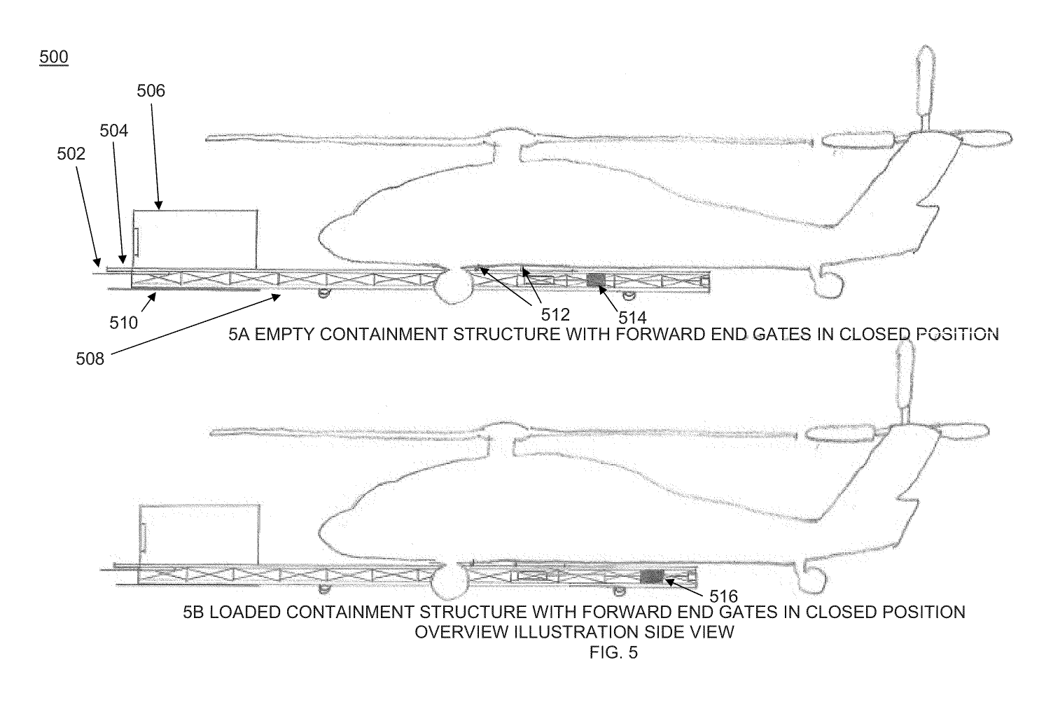

FIG. 5 is an illustration of an embodiment 500 of the device from the side perspective. Embodiments are symmetrical along their length, so both the left and right sides appear identical. Beginning at the forward end and continuing toward the aft end the following are visible. At the immediate front is static probe 502 which extends forward of the entire device. Immediately behind the static discharge probe is the flat, rectangular horizontal surface of transfer platform 504 which is visible on edge from the side view. Behind the transfer platform is the large rectangular box structure of the Containment Structure (CS) 506 resting atop boom 508. The boom is visible beneath the CS and extends its full length around the CW to its aft end. Heat deflector shield 510 is visible on edge view mounted to the underside of the forward end of the Boom and underneath the CS and transfer platform. Between the CS and CW, but closer to the CW, aircraft attachment points 512 are visible on the upper side of the boom. CW 514 is visible toward the aft end of the device. The side of CW 514 appears as a solid square contained within the boom structure. FIG. 5A depicts CW 514 in the normal stored position with an empty CS. FIG. 5B depicts CW positioned 516 further aft of the normal stored position to compensate for a loaded CS.

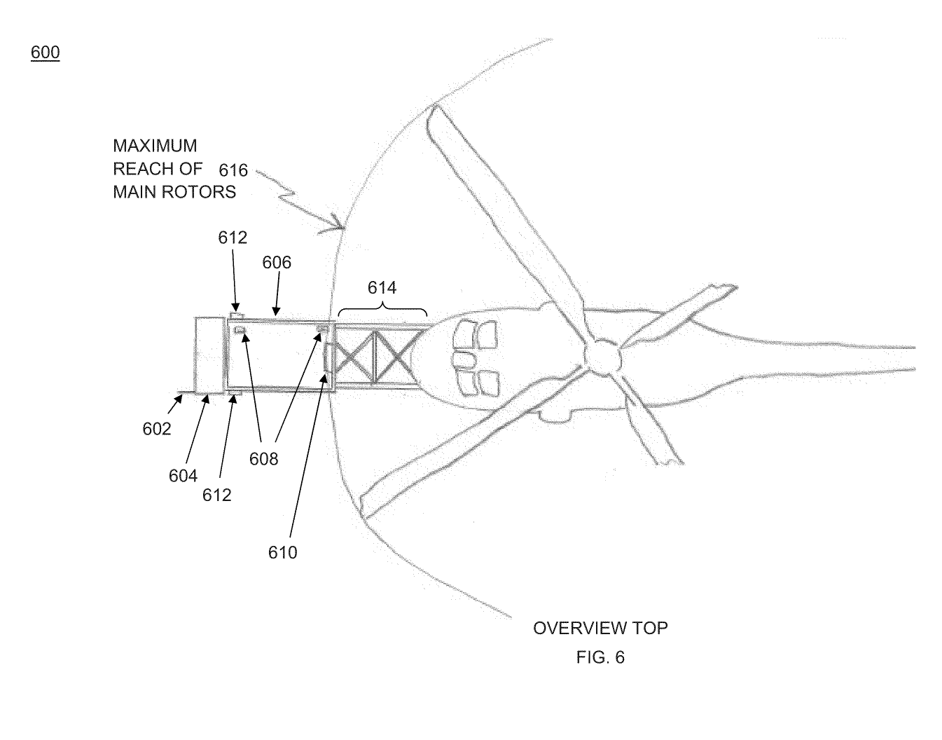

FIG. 6 is an illustration of an embodiment 600 of the device from the top perspective. In this view, the device is mounted to an aircraft so only the CS and forward portion of the boom are visible. At the immediate front is static probe 602 which extends forward of the entire device. Immediately behind the static discharge probe is the flat, rectangular horizontal surface of transfer platform 604. Behind the transfer platform is the large rectangular open-top box structure of Containment Structure (CS) 606 resting atop the boom. Two safety strap hook up points 608 are visible in the floor of the CS 606. The spotlights, loudspeaker, and intercom housing can be clearly seen mounted 610 inside and on the aft end of CS 606. The motor housings 612 that control the FE gates are visible on both exterior sides of CS 606. The boom is visible 614 between CS 606 and the aircraft. The maximum reach of the main rotors 616 is depicted to demonstrate how the device extends beyond that point to prevent the aircraft rotors from coming in contact with the vertical surface.

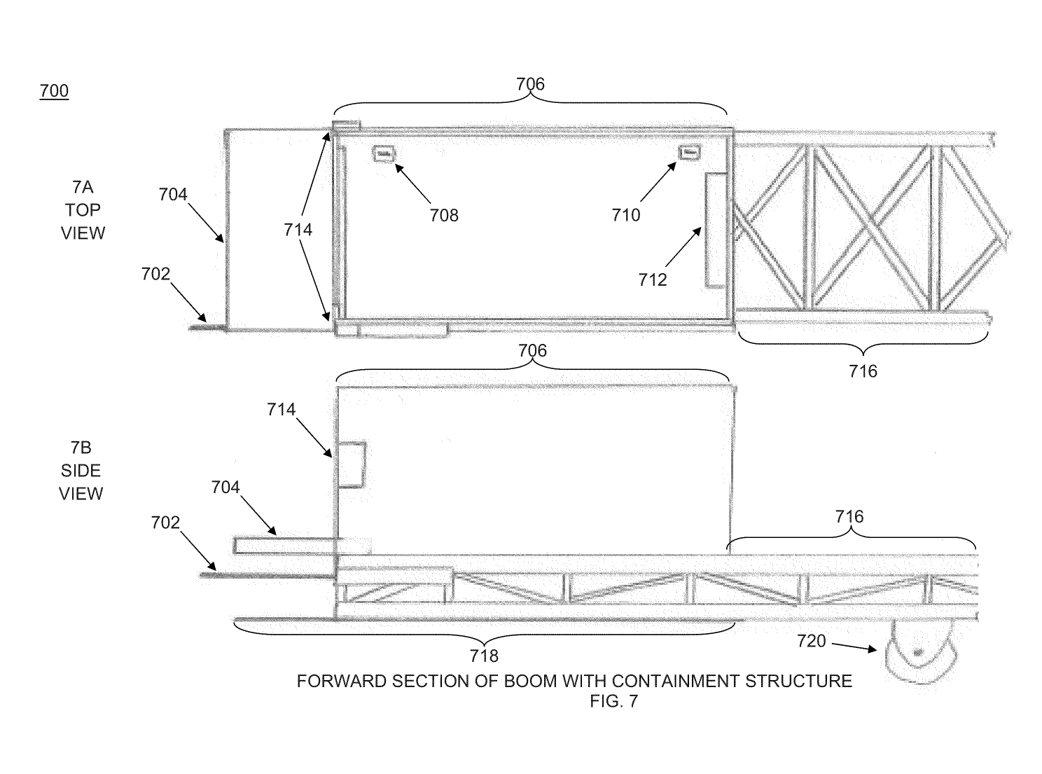

FIG. 7 illustrates an embodiment 700 of the forward section of the boom with the CS. 7A shows the device from the top. Beginning at the forward end and continuing toward the aft end the following are visible. At the immediate front is static probe 702 which extends forward of the entire device. Immediately behind static discharge probe 702 is the flat, rectangular horizontal surface of transfer platform 704. Behind transfer platform 704 is the large rectangular open-top box structure of Containment Structure (CS) 706. Two attachment points for safety straps are visible in the floor of the CS, one 708 toward the front and one 710 toward the rear. Spotlights, loudspeaker, and intercom housing 712 are mounted inside and on the aft end of the CS. Motor housings 714 that control the Forward End (FE) gates are visible on both exterior sides of CS 706. Boom 716 is visible emerging from the rear end of the CS in the direction of the aircraft. 7B shows the device from the side. Beginning at the forward end and continuing toward the aft end the following are visible. At the immediate front is static discharge probe 702 which extends forward of the entire device. Immediately behind static discharge probe 702 is the flat, rectangular horizontal surface of transfer platform 704 which is visible on-edge from the side view. Behind transfer platform 704 is the large rectangular box structure of CS 706 resting atop the boom. Motor housing 714 that controls the FE gate is visible on the outside of the CS at the forward end. Heat deflector shield 718 is visible on edge view, mounted to the underside of the forward end of the Boom and underneath CS 706 and transfer platform 704. The Boom extends 716 past the rear end of the CS in the direction of the aircraft. One of the four casters 720 which enable the device to be wheeled into position beneath the aircraft is shown.

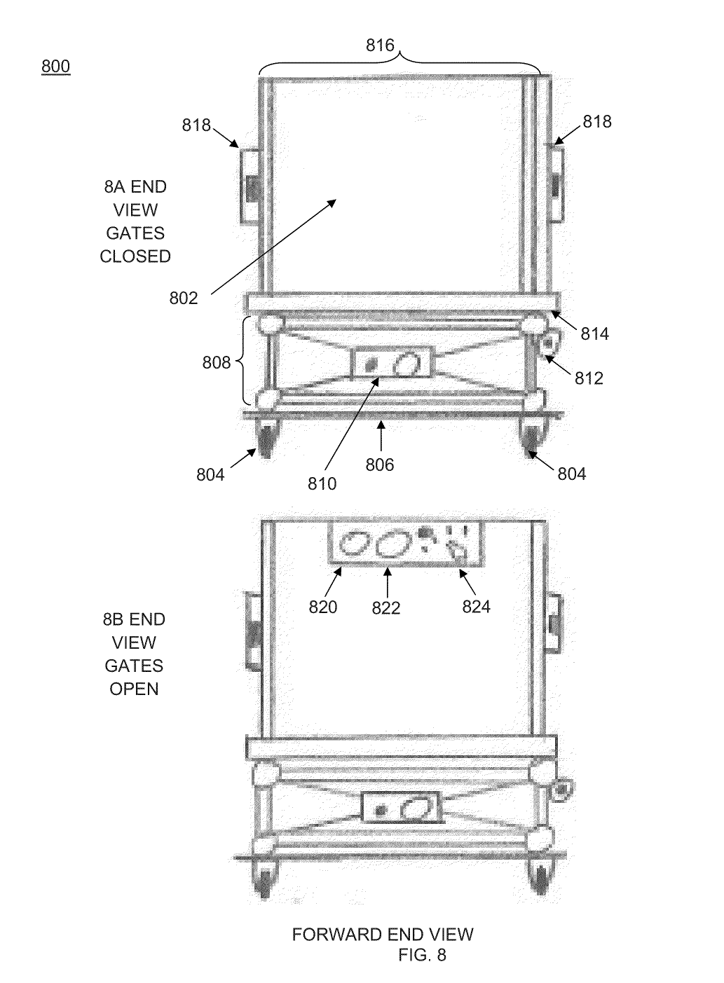

FIG. 8 illustrates an embodiment 800 of the Forward End (FE) of the device. FIG. 8A illustrates the FE view with the FE gates in closed position 802. Beginning from the bottom up, two of the four casters are visible 804, one on each bottom rail of the Boom. Just above the casters, the FE of the heat shield 806 is visible on edge. The Boom structure consisting of parallel rails and cross members is visible in end view 808 just above the heat shield. A laser range finder and spotlight are contained in box housing 810 visible on the very end of Boom 808. Static discharge probe and housing 812 are visible in end-view mounted on the right side of Boom 808. Leading edge of transfer platform 814 is visible in end view above Boom 808 and under CS 816. The FE gates of the containment structure are in the closed and overlapped locked position providing secure transport for any persons or items in CS 816. Motor housings 818 for the FE gates are visible on both the left and right external sidewalls of CS 816. FIG. 8B illustrates the FE view with the FE gates in the open and locked position. This view is nearly identical to FIG. 8A, except that now the interior of the CS is visible revealing loudspeaker 820, spotlight 822, and intercom connector switch 824 mounted in the rear interior of CS 816.

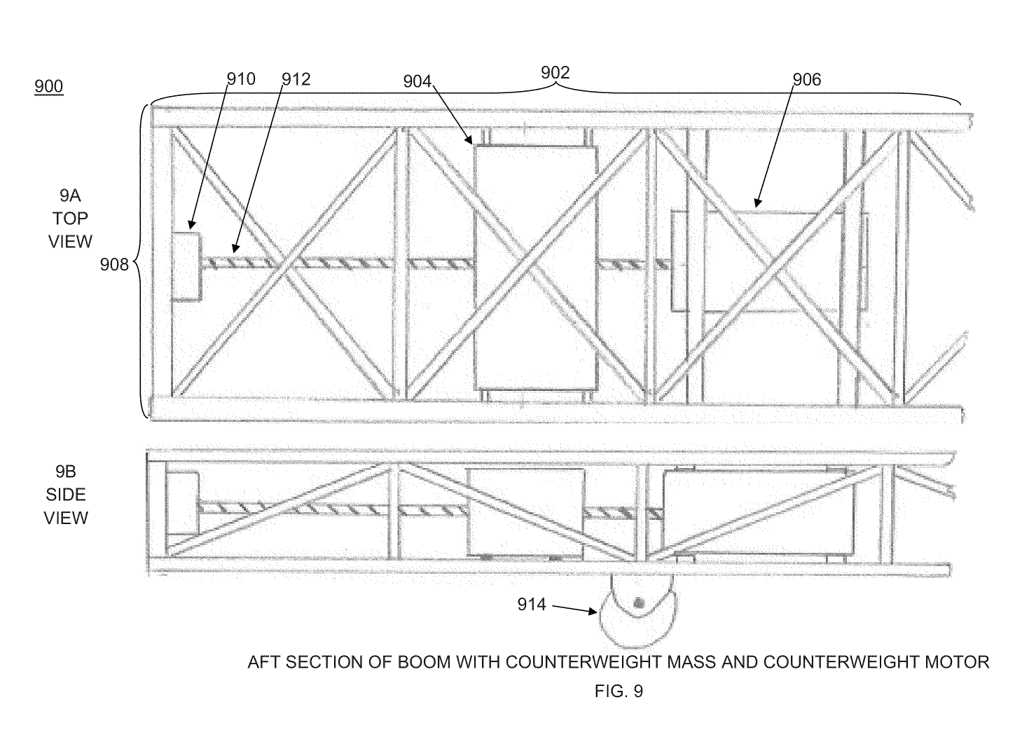

FIG. 9 illustrates an embodiment 900 of the aft section of Boom 902 with Counterweight (CW) 904 and Counterweight Motor 906. FIG. 9A illustrates the top view of the device. Beginning at aft end 908, the CW, screw housing 910 is visible securely mounted to the interior aft end 908 of Boom 902. CW screw 912 extends through the center of CW 904 to CW motor 906. In embodiments, CW 904, CW motor 906, and CW screw 912 are mounted wholly within the frame of the Boom. FIG. 9B illustrates the side view of the device. It depicts the same elements as FIG. 9A, and in addition, one of the four casters 914 which enable the device to be wheeled into position beneath the aircraft is shown.

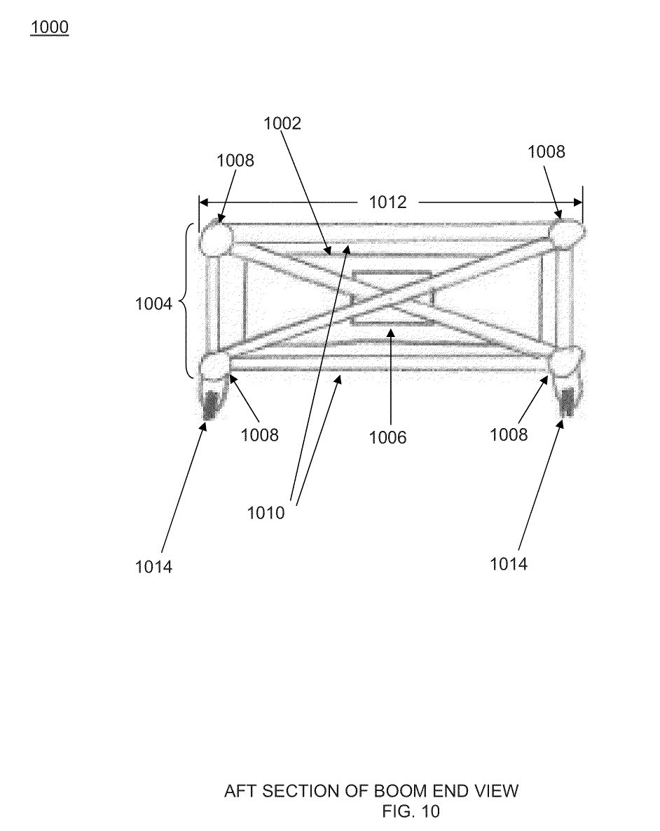

FIG. 10 illustrates an embodiment 1000 of the back of the device. From this view, Counterweight CW 1002 is visible as a large rectangular mass contained within boom 1004. A small rectangular housing 1006 on the end of the boom secures one end of the screw (not visible) which turns to move CW 1002. In embodiments, boom 1004 consists of parallel rails 1008 interlocked with each other via horizontal angular cross members 1010. In embodiments, boom width 1012 is identical to the width under the CS and uniform along its entire length. Two of the four casters which enable the device to be wheeled into position beneath the aircraft are shown 1014.

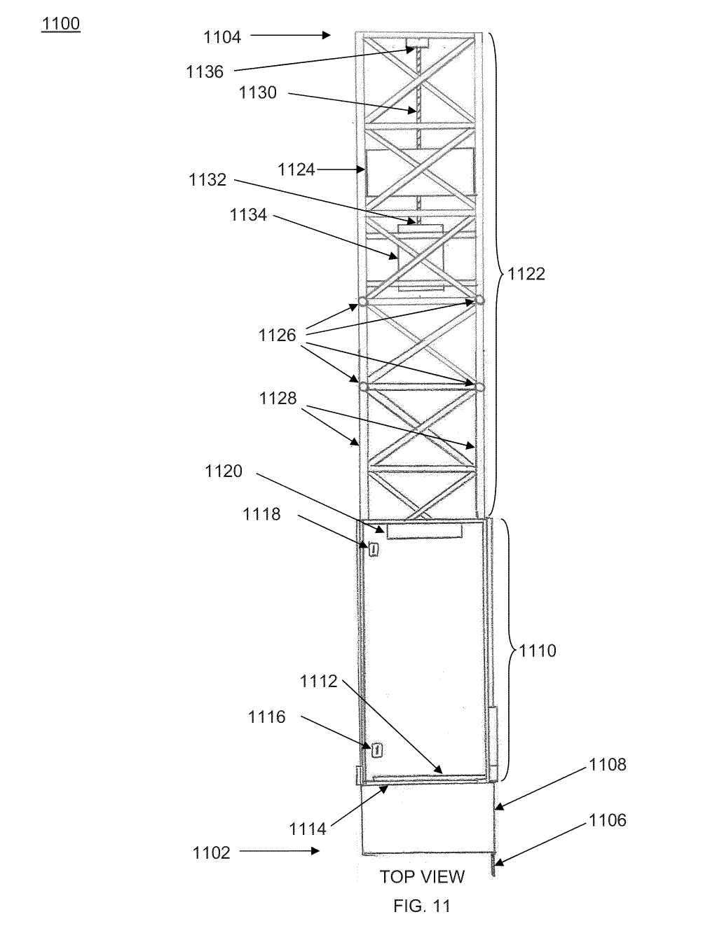

FIG. 11 illustrates an embodiment 1100 of the device from the top when not attached to the aircraft. Beginning at forward end (FE) 1102 and continuing toward the aft end 1104, the following are visible. At the immediate front is static probe 1106 which extends forward of the entire device. Immediately behind static discharge probe 1106 is the flat, rectangular horizontal surface of the transfer platform 1108. Behind transfer platform 1108 is the large rectangular open-top box structure of Containment Structure CS 1110 with the FE gates 1112 and 1114 in the closed and overlapped locked position, for embodiments. Two attachment points for safety straps are visible in the floor of CS 1110, one 1116 towards front 1102, and one 1118 towards rear 1104. A top view of the spotlight, loudspeaker, and intercom connector box 1120 mounted inside CS 1110 is also visible. Boom 1122 is visible as it emerges from beneath CS 1110, and extends its full length around Counterweight CW 1124, to aft end 1104. Between CS 1110 and CW 1124, but closer to CW 1124, the aircraft attachment points are visible as circular points 1126 on each Boom rail 1128. CW 1124 is visible as a rectangle between boom attachment points 1126 and boom aft end 1104. CW screw 1130 is visible from its forward attachment point 1132 to CW motor 1134, through the body of CW 1124, to its point of attachment 1136 on the aft end 1104 of boom 1122.

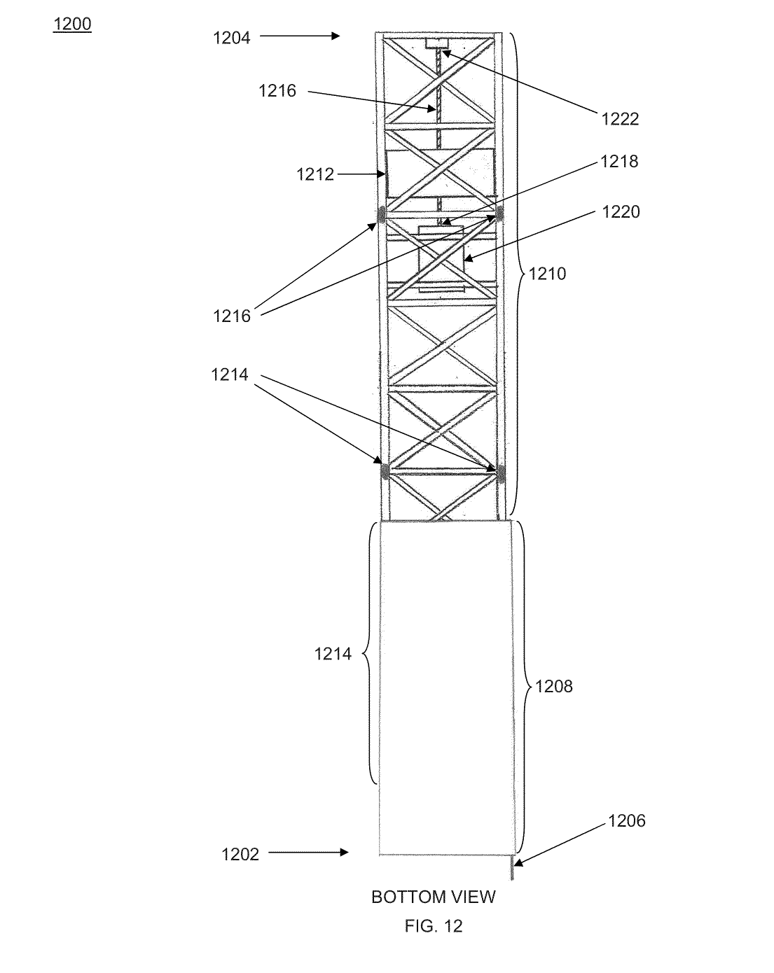

FIG. 12 illustrates an embodiment 1200 of the device from the bottom. Beginning at forward end 1202, and continuing toward the aft end 1204, the following are visible. At the immediate front is static probe 1206, which extends forward of the entire device. Immediately behind static discharge probe 1206 is the flat, rectangular horizontal surface of heat deflector shield 1208. Boom 1210 is visible as it emerges from above heat deflector shield 1208 and extends its full length around Counterweight CW 1212 to aft end 1204. Between Containment Structure CS 1214 and CW 1212, four sets of wheels/castors (two per rail with two forward 1214 and two aft 1216 of the attachment points) are visible. CW 1212 is visible as a rectangle between the boom attachment points and boom aft end 1204. CW screw 1216 is visible from its forward attachment point 1218 to CW motor 1220, through the body of CW 1212, to its point of attachment on the aft end of the boom 1222.

FIG. 13 illustrates an embodiment 1300 of the forward section of the boom with the Containment Structure (CS) including a liquid center of gravity equilibrium embodiment. 13A shows the device from the top. 13B shows the device from the side. Container 1305 on the forward end rests on an expandable bladder filled with the previously described liquid, residing in tray 1310 beneath forward container 1305. Forward container 1305 is able to move up and down in a stable manner utilizing four pins 1315 affixed to the tray bottom which extend vertically through the bottom of container 1305. In embodiments, pins 1315 move through grommets. The forward bladder is connected via a conduit 1320 to an aft bladder (see FIG. 14) contained in a sealed and air pressurized reservoir located in the aft section of the boom.

FIG. 14 illustrates an embodiment 1400 of the aft section of the boom including a liquid center of gravity equilibrium embodiment. 14A shows a schematic diagram of a system with an empty container. 14B shows a schematic diagram of a system with a partially loaded container. 14C shows a schematic diagram of a system with a fully loaded container. As described in FIG. 13, an embodiment for maintaining the center of gravity equilibrium utilizes a closed bladder and reservoir system containing a liquid of specific density sufficient for this application. Forward bladder is connected via a liquid transfer conduit 1405 to an aft bladder contained in a sealed and air pressurized liquid reservoir 1410 located in the aft section of the boom. With no load in the container 14A, the liquid remains at rest and the entire system is calibrated to maintain the desired center of gravity. As a load is placed in the container 14B, a downward pressure is created on the forward bladder 1415 below and liquid is forced through connector conduit 1405 into the aft bladder 1420 contained in the pressurized reservoir vessel 1410. In embodiments, the system is calibrated so that the total weight of the fluid transferred from the forward bladder and the reservoir will be sufficient to compensate for the weight of the added load, thus maintaining the overall center of gravity. Conversely, as a load is removed from the container, the pressurized reservoir will force liquid to flow out of the aft bladder through the connecter conduit into the forward bladder. For embodiments, this is a passive system requiring no moving parts, and the conduit is a pipe.

Alternatively, it may be possible with airframes of certain capability to dispense with a Center of Gravity compensation system altogether. In these cases, for embodiments, it will be necessary to place a maximum load limit on the containment system to maintain airworthiness under load.

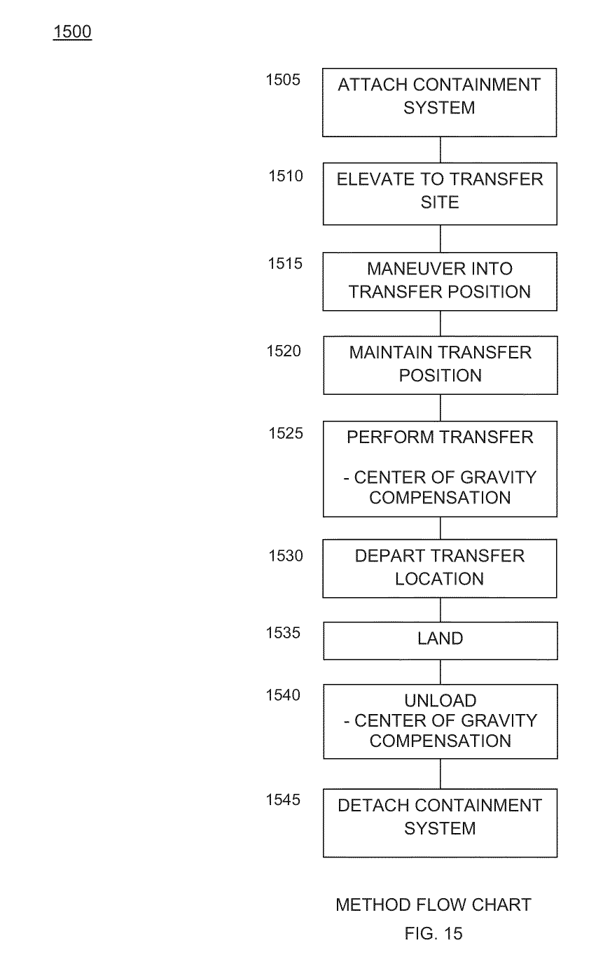

FIG. 15 is a flow chart of a method 1500 for an embodiment of the invention. The method begins with attaching the containment system to the receiving platform 1505. Next is elevating to the transfer site 1510. Next is maneuvering into transfer position 1515. Next is maintaining the transfer position 1520. Next is performing the transfer 1525. Next is departing the transfer location 1530. Next is landing 1535. Next is unloading 1540. Next is detaching the containment system 1545.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. Other and various embodiments will be readily apparent to those skilled in the art, from this description, figures, and the claims that follow. It is intended that the scope of the invention be limited not by this detailed description, but rather by the claims appended hereto.

What is claimed is:

1. A vertical surface transfer device attachable to a platform for transferring payloads proximate vertical surfaces comprising:
at least one boom;
a delivery component at a forward end of said boom;
at least one attachment point connecting said boom to said platform; and
at least one cockpit control in said platform to control an aspect of said delivery component.

2. The device of claim 1 wherein said platform is a helicopter wherein said at least one boom extends beyond maximum reach of a main rotor.

3. The device of claim 2 wherein said delivery component comprises a containment structure.

4. The device of claim 1 wherein said delivery component comprises an open-top box structure.

5. The device of claim 1 said delivery component comprises a nozzle.

6. The device of claim 1 comprising a mesh screen.

7. The device of claim 1 comprising a heat shield.

8. The device of claim 1 comprising a static discharge probe.

9. The device of claim 1 comprising a transfer platform.

10. The device of claim 1 comprising forward end doors.

11. The device of claim 1 comprising a range finder.

12. The device of claim 1 comprising at least one anti-vibration component.

13. The device of claim 1 comprising at least one counterweight comprising screw, motor, and mass components.

14. The device of claim 1 comprising at least one counterweight comprising a liquid equilibrium system.

15. A method for transferring individuals and objects at vertical surfaces comprising:
attaching a delivery system to a rotary wing aircraft, said delivery system comprising a delivery component, at least one boom, at least one attachment point, and at least one cockpit control;
elevating to site of said vertical surface;
maneuvering said rotary aircraft into a transfer position;
maintaining said transfer position; and
performing said transfer.

16. The method of claim 15 comprising at least one counterweight for said delivery system and a counterweight calibration step.

17. The method of claim 15 comprising detaching and removing said delivery system after landing after said transfer step.

18. The method of claim 15 comprising delivery system jettison upon an emergency.

19. The method of claim 15 comprises adding a payload to said delivery component prior to said elevating step.

20. A system for transferring individuals and objects at vertical surfaces comprising:
at least one boom extending beyond a maximum reach of a main rotor of a rotary wing aircraft, said boom fitting entirely between a ground surface and bottom of said aircraft, said boom structure comprising parallel rails and cross members; said parallel rails interlocked with each other via horizontal angular cross members, width of said boom being uniform along its length;
at least one attachment point between said boom and said aircraft, said at least one attachment point configured to jettison said system from said aircraft by cabin crew of said aircraft to preserve safety of said aircraft and said crew;
a protected jettison switch to activate said jettisoning said system from said aircraft;
a containment structure comprising attachment points for safety straps, one towards a front, and one towards a rear of said containment structure, width of said containment structure equal to said width of said boom;
a mesh screen providing enclosure for said containment structure;
a heat shield beneath said containment structure;
a transfer platform, constructed to slide in and out of a space between a bottom of said containment structure and said heat shield, said transfer platform acting as a bumper;
forward end walls of said containment structure, extending forward in an open position to equal length of said transfer platform, said forward end walls being compressible, movable toward said rear of said containment structure, said forward end walls forming gates of said containment structure said gates having a closed and overlapped locked position providing secure transport;
motors and motor housings on outside of said containment structure at said forward end controlling said forward end gates;
a compressible static discharge probe comprising a metal rod mounted underneath said containment structure;
a laser range finder and an indicator displaying a distance between said containment structure and a rescue surface;
at least one camera, spotlight, video screen, loudspeaker, microphone, and at least one switch to enable a pilot or a copilot to communicate with a person in said containment structure via at least one of said loudspeaker and a headset supporting two-way communication between said crew and an individual equipped with a headset riding in said containment structure, said spotlights, loudspeaker, and intercom housing mounted inside and on said aft end of said containment structure;
an anti-vibration component preventing harmonic vibration;
four casters mounted on bottom of said boom, two on each bottom rail of said boom, one forward and one aft, which enable said system to be wheeled into place for mounting beneath said aircraft;
at least one counterweight at least partially offsetting weight of contents of said containment structure; and
a counterweight screw, counterweight motor, and counterweight mass, and a liquid equilibrium system, said counterweight mass and said counterweight screw mounted within interior aft end of said boom, said counterweight screw extending through center of said counterweight mass to said counterweight motor, wherein said counterweight mass, counterweight motor, and counterweight screw are mounted wholly within frame of said boom, said liquid equilibrium system comprising a closed bladder and reservoir system containing a liquid of a specific density, and a forward bladder connected via a liquid transfer conduit to an aft bladder contained in a sealed and pressurized liquid reservoir located in aft section of said boom.
